(19) United States
(12) Patent Application Publication
(10) Pub. No.: US 2017/0370523 A1
(43) Pub. Date: Dec. 28, 2017

(54) ELECTROSTATIC OIL RING, ELECTROSTATIC OIL RING ASSEMBLY, AND ELECTRODYNAMIC MACHINE

(71) Applicant: SIEMENS INDUSTRY, INC., Alpharetta, GA (US)

(72) Inventors: Daniel Lasorso, Norwood, OH (US); Sumit Singhal, Mason, OH (US)

(21) Appl. No.: 15/535,083

(22) PCT Filed: Jan. 20, 2016
(86) PCT No.: PCT/US2016/014035

§ 371 Date: Jun. 12, 2017

Related U.S. Application Data
(60) Provisional application No. 62/106,289, filed on Jan. 22, 2015.

(51) Int. Cl. F16N 7/22; G01L 19/14; F16N 7/38; F16C 33/10; F16C 17/02; H02K 7/09; F01M 1/08

(52) U.S. Cl. CPC F16N 7/22; H02K 7/09; G01L 19/146; F01M 1/08; F16C 33/1045; F16C 17/02; F16N 7/38

(57) ABSTRACT

An electrostatic oil ring (130, 150) has an annular ring body (142, 152) with a surface (132, 134, 136, 138, 154), wherein a portion of the surface (132, 134, 136, 138, 154) carries an electrostatic coating (140, 156) which electrostatically attracts lubricant (35a) in a lubricant reservoir (35) when the electrostatic oil ring (130, 150) passes through the lubricant reservoir (35). Further, an electrostatic oil ring assembly with a plurality of electrostatic oil rings (130, 150), and a dynamoelectric machine with an electrostatic oil ring assembly are provided.

### CROSS REFERENCE TO RELATED APPLICATIONS

This Application claims benefit of U.S. Provisional Patent Application No. 62/106,289 filed 22 Jan. 2015 in the United States Patent and Trademark Office, the content of which is herein incorporated by reference in its entirety.

### BACKGROUND

### 1. Field

Aspects of the present invention generally relate to an electrostatic oil ring, an electrostatic oil ring assembly, and an electric machine comprising an electrostatic oil ring assembly.

### 2. Description of the Related Art

An oil ring, also referred to as ring oiler, is a form of oil-lubrication system for bearings usually arranged in rotating machine, for example electrodynamic machines. An oil ring usually is a metal ring placed around a horizontal shaft adjacent to a bearing of a machine or engine. An oil sump is underneath the shaft and the oil ring is large enough to dip into the oil of the oil sump. As the shaft rotates, the ring is carried with the shaft. The oil ring then picks up some oil out of the oil sump and deposits the oil for example onto the shaft from where it flows sideways and lubricates the bearings, or directly onto the bearing.

Electrodynamic machines, such as horizontal shaft induction motors, have rotating shafts restrained by rolling element, hydrodynamic, or hydrostatic bearings. Hydrodynamic bearings can generate a self-sustaining pressurized lubricant liquid film interface between the bearing surface and the corresponding shaft journal. Lubricant forming the lubricant film needs to be refreshed to replace that which is inevitably squeezed out of the bearing/journal interface due to their relative rotation. Oil replenishment also conveniently transfers heat generated within the interface or by thermal gradient transfer between the surfaces away from the bearing, for example to a sump. For brevity, lubricant will hereafter be referred to as oil, as it is a commonly used industrial lubricant.

Induction motors oftentimes employ oil ring lubricated hydrodynamic bearings to support and constrain the rotating shaft. The hydrodynamic bearings are often contained in a bearing block portion of a bearing housing mounted on both axial ends of the motor. The bearing housing in cooperation with the motor housing forms an oil sump having a maximum fluid fill level below the motor shaft and bearing, so that the shaft does not come in direct contact with the sump oil. The bearing includes one or more axially or laterally restrained annular oil rings that capture the motor shaft journal within its inner cylindrical surface. The oil ring is in direct contact with the motor shaft journal at the ring's approximately 12 o'clock upper position. The lower portion of the oil ring proximal its 6 o'clock lower position is dipped into the oil within the sump. The oil ring can include a grooved or otherwise textured surface to enhance friction contact with the shaft journal. Motor shaft rotation imparts oil ring rotation. As the oil ring rotates, it carries and transports an oil film on its surface from the sump oil and deposits the oil into the bearing as the previously dipped portion rotates from its prior 6 o'clock position to a new 12 o'clock position in contact with the shaft journal.

An oil ring's oil transfer rate from the sump to the shaft journal bearing is a function of and proportional to shaft rotation speed. Under low RPM, high load conditions the oil rings may not be able to maintain a desired oil transfer rate from the sump to the bearing. Conversely, under high RPM conditions, oil may be slung off the ring due to centrifugal forces before a sufficient quantity can reach the bearing during the rotational trip from sump to bearing.

### SUMMARY

Briefly described, aspects of the present invention relate to an electrostatic oil ring, an electrostatic oil ring assembly, and an electrodynamic machine, for example an induction motor, comprising an electrostatic oil ring assembly.

A first aspect of the present invention provides an electrostatic oil ring comprising an annular ring body with a surface, wherein at least a portion of the surface carries an electrostatic coating which electrostatically attracts lubricant in a lubricant reservoir when the oil ring passes through the lubricant reservoir.

A second aspect of the present invention provides an electrostatic oil ring assembly comprising a plurality of electrostatic oil rings, each oil ring comprising an annular ring body with a surface, wherein at least a portion of the surface carries an electrostatic coating which electrostatically attracts lubricant in a lubricant reservoir when the oil ring passes through the lubricant reservoir.

A third aspect of the present invention provides an electrodynamic machine comprising an internal lubricant reservoir; and at least one hydrodynamic bearing without a pressurized oil feed system, the hydrodynamic bearing comprising at least one oil ring in fluid communication with lubricant in the internal lubricant reservoir, the at least one oil ring comprising an annular ring body with a surface, wherein at least a portion of the surface carries an electrostatic coating.

### BRIEF DESCRIPTION OF THE DRAWINGS

FIG. 1 illustrates a schematic perspective view of a bearing lubrication system as incorporated in an idealized exemplary induction motor, with the motor shown in phantom in accordance with an exemplary embodiment of the present invention.

FIG. 2 illustrates a partial, axial, cross-sectional view of the bearing lubrication system focusing on an induction motor bearing housing in accordance with an exemplary embodiment of the present invention.

FIG. 3 illustrates a partial, radial, cross-sectional view of the bearing lubrication system of FIG. 1 in accordance with an exemplary embodiment of the present invention.

FIG. 4 illustrates a schematic view of an induction motor incorporating the bearing lubrication system, showing the motor in a generally level, horizontal position in accordance with an exemplary embodiment of the present invention.

FIG. 5 illustrates a schematic view of an induction motor incorporating the bearing lubrication system, showing the motor in a rolled position about the shaft axis relative to the horizontal position of FIG. 4 in accordance with an exemplary embodiment of the present invention.

FIG. 6 illustrates a schematic view of an induction motor incorporating the bearing lubrication system, coupled to a motor drive control, for varying lubrication system flow parameters in accordance with an exemplary embodiment of the present invention.

FIG. 7 illustrates a schematic 3-dimensional view of an oil ring, in accordance with an exemplary embodiment of the present invention.

FIG. 8 illustrates a schematic 2-dimensional view of a further embodiment of an oil ring in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of an electrostatic oil ring, an electrostatic oil ring assembly, and an electric machine comprising an electrostatic oil ring assembly. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

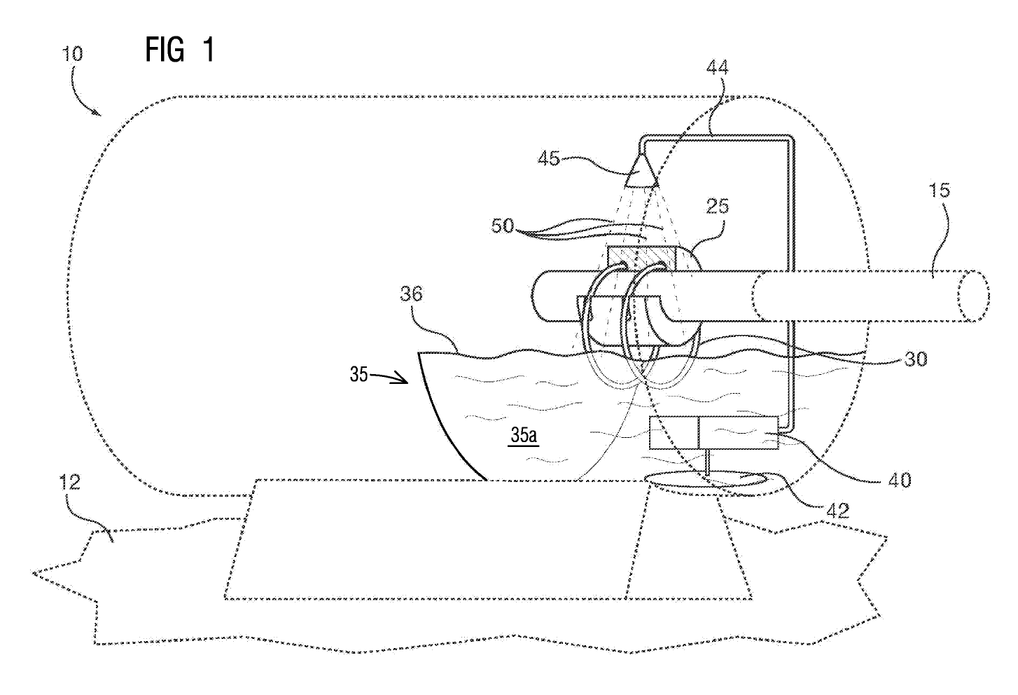

FIG. 1 shows a schematic perspective view of a bearing lubrication system as incorporated in an idealized exemplary induction motor 10, with the motor 10 shown in phantom, mounted on a deck surface 12. The deck surface 12 may be stationary, for example and without limitation mounted to for example a factory building floor or in a moving object, which can be for example and without limitation a marine vessel, railroad locomotive, construction crane, or mining drag line. As illustrated, the motor 10 is shown in phantom line drawing, because its electrodynamic components are of conventional construction.

A motor shaft 15 of the induction motor 10 is supported by a bearing 25, for example a hydrodynamic bearing. FIG. 1 shows a pair of annular oil rings 30. The induction motor 10 can comprise one or more oil rings 30. Each oil ring 30 can be in direct contact with the motor shaft 15, in particular a motor shaft journal at the ring's approximately 12 o'clock upper position. The lower portion of the oil rings 30 at an approximate 6 o'clock lower position is dipped into oil 35a within an internally defined oil sump 35. It should be noted that the oil sump 35 and oil 35a are herein also referred to as lubricant reservoir 35 and lubricant 35a. A fill level 36 of the oil sump 35 is schematically depicted, and is below the lower 6 o'clock surface of the rotating shaft 15 and bearing 25 so as not to whip or foam the oil 35a, or cause unwanted rotating drag on the shaft 15. Rotation of the motor shaft 15 imparts rotation of the oil rings 30. As the oil rings 30 rotate, they carry and transport an oil film on their surface from the oil sump 35 and deposit oil 35a into the bearing 25 as the previously dipped portion rotates from its prior 6 o'clock position to a new 12 o'clock position in contact with the shaft journal. The oil sump fill level 36 will flow to a horizontal level position under the influence of gravity, no matter what the relative orientation of the motor 10. If the motor 10 is installed in a moving object, such as a ship with a rolling deck, it is likely at some rolling orientations that the oil rings 30 will not be dipped into internal oil sump 30.

In an exemplary embodiment, a bearing lubrication system can provide a parallel oil delivery mechanism to the bearing 25, and is complimentary to the existing installed oil delivery system comprising the oil rings 30. As FIG. 1 shows, the bearing lubrication system includes an oil sump pump 40, herein also referred to as lubricant reservoir pump 40, retained within the motor's existing internal oil sump 35. The pump 40 may be conveniently electrically powered and have variable pumping capacity rates. Power for the pump 40 may be routed into the internal oil sump 35 through one of the existing fitting locations or a new aperture may be added in design revisions. The pump 40 has an oil intake 42, herein also referred to as lubrication intake 42, in communication with the oil 35a retained in the oil sump 35. The oil intake 42 is oriented in the sump 35 in a position most likely to be below the oil fill line 36 under any or most foreseen motor orientations. The pump oil intake 42 can be mounted to the pump 40 with a two or three degree of motion swivel joint, so that it remains plumb with and below the oil fill line 36 during pump motion when installed on a moving object. Alternatively, for motor applications in moving objects, the pump oil intake 42 may be constructed with a check valve upstream of a smaller reserve supply of oil retained in the intake 42 if the intake loses continuous fluid communication with the oil 35a of the oil sump 35 by being above the sump oil fill line 36 during some transient orientations of the motor 10.

The pump 40 generates a pressurized lubricant discharge that is routed through discharge line 44, the distal outlet of which is oriented proximal the bearing 25, so that the discharge is directed to cause oil 35a to contact directly or flow into the bearing 25 and shaft 15, in particular a shaft journal interface/shaft bearing interface. The discharge line 44 may be constructed of any desired rigid or flexible pipe or tubing, and is fixed to the motor 10, in particular to a housing of the motor 10, by any chosen fastener or bracket structure familiar to those skilled in the art. An oil nozzle 45, herein also referred to as lubricant nozzle 45, or other fluid spray pattern regulating component may be coupled to the distal end of the discharge line 44 to alter the discharge spray pattern of the lubricant spray 50. One skilled in the art may choose to substitute other components for the nozzle 45, for example an orifice, pulsed injector or aerator, in order to achieve other desired oil spray patterns for a particular application

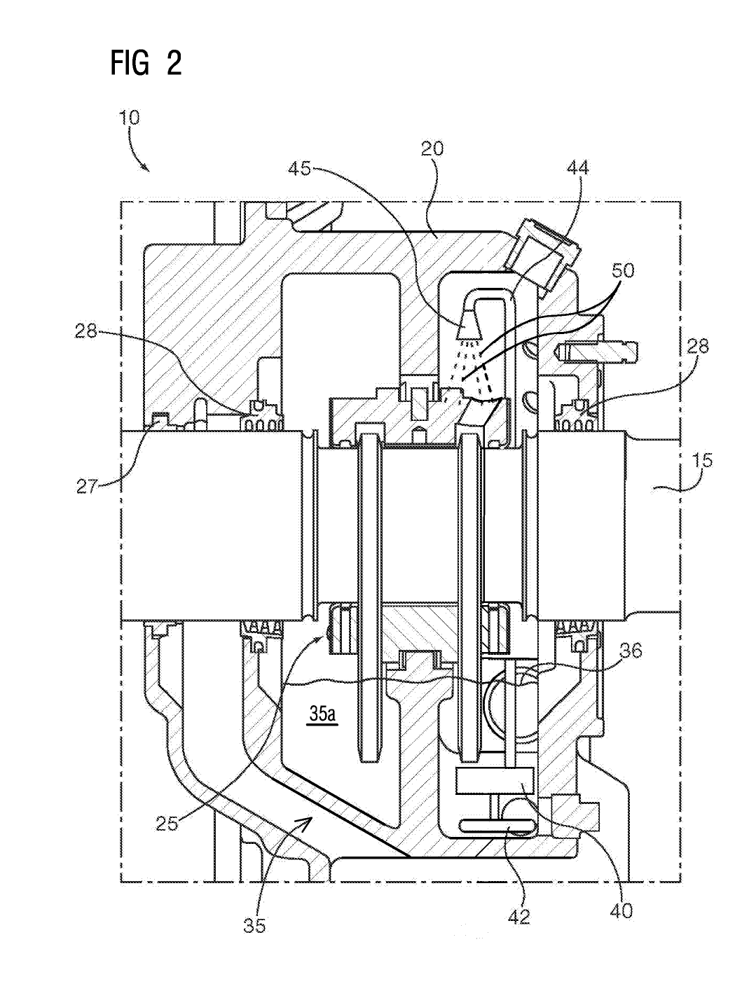

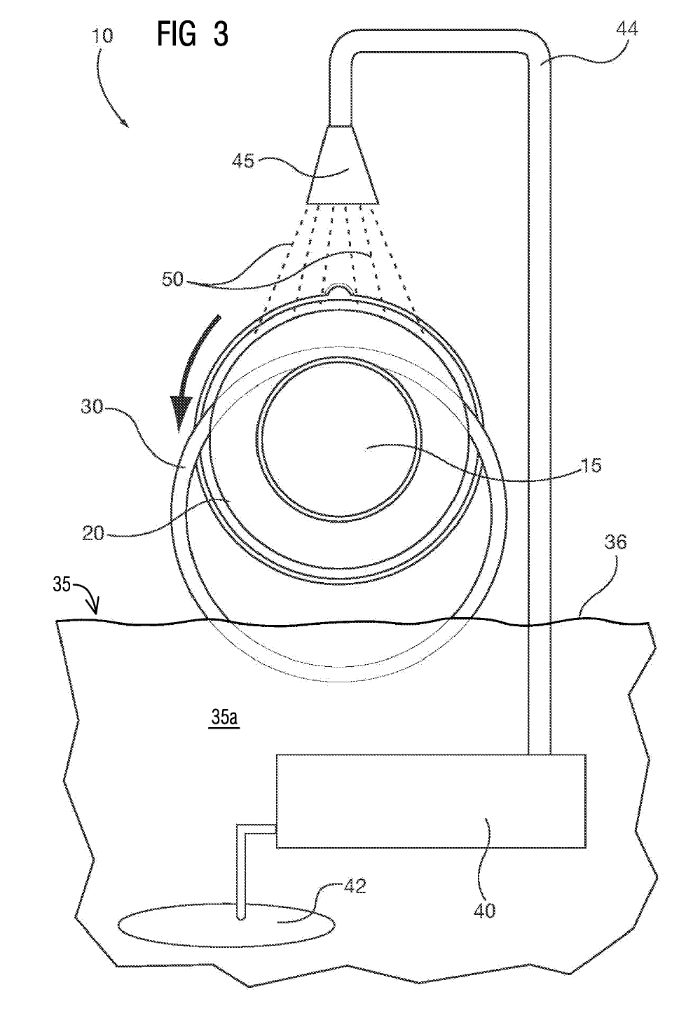

FIG. 2 is a partial, axial, cross-sectional view of the bearing lubrication system focusing on an induction motor bearing housing, and FIG. 3 is a partial, radial, cross-sectional view of the bearing lubrication system of FIG. 1. As shown in FIGS. 2-3, the motor shaft 15 is retained in a bearing housing 20 that includes the bearing 25 and an air seal 27 which isolates for example oil from the electrodynamic components in an interior of the motor 10. A pair of known elastomeric labyrinth seals 28 may flank the bearing 25 and corresponding journal surface of the shaft 15 to inhibit oil flow out of the bearing region axially along the shaft 15, and to retain a reserve of oil for replenishment of the oil film formed between the bearing 25 and corresponding journal surfaces. As described before in connection with FIG. 1, the oil rings 30, the oil sump 35 with fill level 36, the pump 40 with intake 42, the discharge line 44 with nozzle 45 and oil spray 50 are also illustrated in FIGS. 2-3.

In operation, the parallel or auxiliary lubrication system enables reliable lubrication (oil) distribution under any motor load or speed operating conditions, whether or not the existing oil rings 30 are in fluid communication with oil 35a in the motor's oil sump 35. The electric sump pump 40 oil flow rate may be selectively adjusted based on anticipated motor operating parameters of the motor 10 or in reaction to sensed operating conditions. Unlike oil rings 30 alone that may not be able to deliver desired oil flow rates to the bearing 25 under low speed, high load or high speed operating conditions, the parallel electric sump pump 40 oil discharge flow rate through the pump nozzle 45 via the discharge line 44 may be adjusted as necessary to meet bearing operational needs. The sump pump 40 lubrication system assures reliable oil delivery to the bearings 25 when the motor 10 is operating in a moving vehicle, should the oil rings 30 lose contact with oil in the internal sump 35.

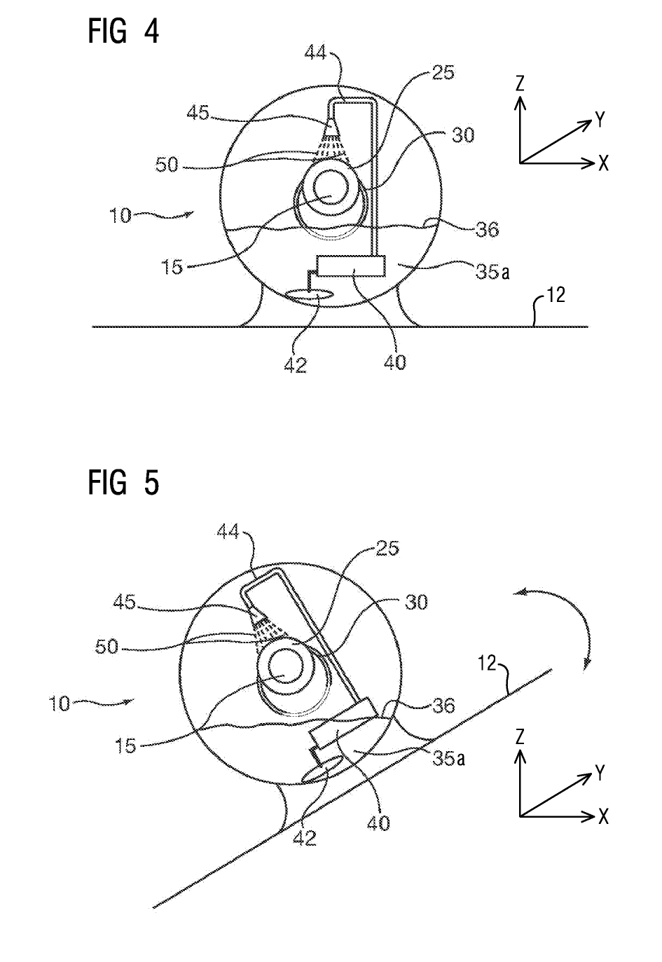

FIG. 4 illustrates a schematic view of the induction motor 10 incorporating the bearing lubrication system, showing the motor 10 in a generally level, horizontal position. FIG. 5 illustrates a schematic view of the induction motor 10 incorporating the bearing lubrication system, showing the motor 10 in a rolled position about the shaft axis relative to the horizontal position of FIG. 4.

In FIG. 4, the motor 10 is mounted on a deck, such as for example a ship deck 12, in a generally horizontal position, as noted by the X-Y-Z horizontal reference axes. When the motor 10 is oriented horizontally, the lubricant fill line 36 is parallel with the deck 12. One or more oil rings 30 are generally plumb with the deck 12 and are dipped into oil 35a below the fill line 36 of the oil sump 35. The lubrication system is discharging oil spray 50 onto the bearing 25 in parallel with oil that is being deposited by the one or more oil rings 30. If desired, the electric sump pump 40 may be de-energized, stopping the oil spray 50, with the bearing 25 lubrication being supplied solely by the one or more oil rings 30.

Referring now to FIG. 5, the deck 12 rolls and pitches, respectively, relative to the X-Y-Z horizontal reference axes. The oil rings 30 are not in continuous fluid communication with oil 35a in the oil sump 35 because they are above the fill line 36. In such situations, the lubrication system maintains oil spray 50 on the bearings 25, so that the bearings 25 receive the flow rate that they need for desired operational performance.

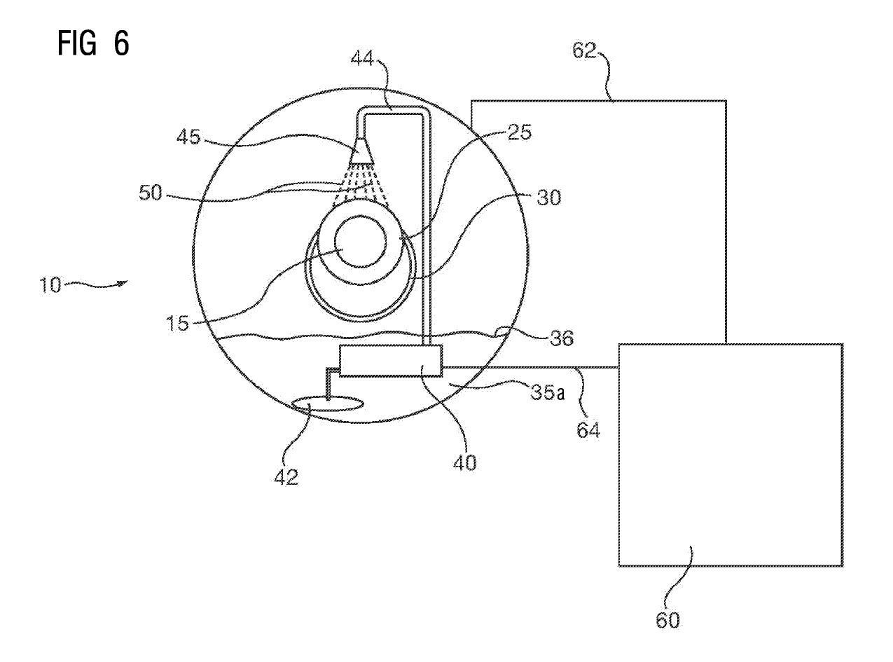

FIG. 6 illustrates a schematic view of an induction motor 10 incorporating the bearing lubrication system, coupled to a control unit 60, for varying lubrication system flow parameters. In FIG. 6, the motor 10 is coupled to a known control unit 60, herein also referred to as motor drive controller 60 via communications pathway 62 in known fashion. The motor drive controller 60 is capable of altering the motor operating parameters, such as speed, torque, and responses to varying loads on the motor 10. Known drive controllers 60 are also capable of monitoring motor operating conditions such as stator winding current and temperature, oil sump temperature, etc. It is contemplated as part of the present invention that the electric oil sump motor 40 may be coupled to the motor drive controller 60, so that the latter may vary the sump pump flow rate, pressure and operating cycle (i.e., continuous, fluctuating or intermittent operation) based on motor operating parameters or in reaction to sensed variations in motor operating parameters.

The lubrication system of the present invention may be incorporated in new induction motors or other electrodynamic machines that have hydrodynamic or rolling element bearings by installing the sump pump 40 and its oil intake 42 within the motor's existing oil sump, or externally installing the pump with its intake in communication with the motor's internal and/or external oil supply reservoir. The sump pump 40 discharge line 44 and nozzle may be located anywhere within or outside the motor housing that enables the nozzle to discharge oil spray 50 on the bearing 25, so that lubricant is deposited where needed in the bearing. The lubrication system component sump pump 40 with intake 42, discharge line 44 and nozzle 45 may be easily field- or shop-retrofitted into existing installed motors.

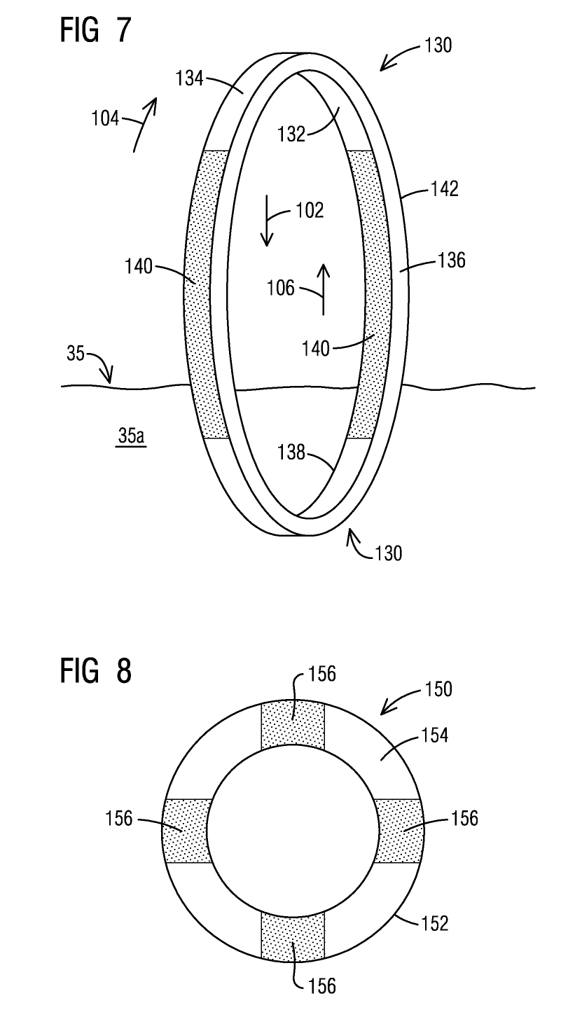

FIG. 7 is a schematic 3-dimensional view of an oil ring in accordance with an exemplary embodiment of the present invention. The exemplary oil ring 130 illustrated in FIG. 7 may be used in machines or engines, for example electrodynamic machines such as electric motors or generators, for example induction motors, turbines and many other rotating machines, for example as described before in FIGS. 1-6. The oil ring 130 may be part of an oil ring assembly comprising a plurality of oil rings 130, or may be an only oil ring 130 arranged in an electrodynamic machine. The electrodynamic machine can comprise additional lubrication systems as described before.

The oil ring 130 can comprise metal. As described previously, during operation of for example an induction motor 10 (see FIG. 1), the oil ring 130 dips into oil sump 35 underneath the shaft 15 of the motor 10. As the shaft 15 rotates, the ring 130 is carried with the shaft 15 of the motor 10, and then picks up some oil 35a out of the oil sump 35 and deposits the oil 35a for example onto bearing(s) 25 and/or the shaft 15 of the induction motor 10. But the oil 35a of the oil sump 35 presents a hydrodynamic resistance to the motion of the ring 130 which causes frictional losses. Additionally, the friction slows down the motion of the ring 130 thus limiting the rate at which the ring 130 is able to deliver oil 35a to the bearing(s) 25 and/or shaft 15.

The oil ring 130 as illustrated in FIG. 7 comprises an exemplary shape of a hollow cylinder. But the oil ring 130 can comprise many other designs, forms or shapes suitable for oil rings (see for example FIG. 8).

The exemplary electrostatic oil ring 130 comprises an annular ring body 142 with an inner surface 132, an outer surface 134, and side surfaces 136 and 138. The inner surface 132 is defined by an inner diameter and the outer surface 134 is defined by an outer diameter of the ring 130. The inner surface 132 and the outer surface 134 are connected via the side surfaces 136 and 138. At least a portion of one of the surfaces 132, 134, 136 and 138 comprises a electrostatic coating 140 that electrostatically attracts the machine oil 35a in the oil sump (lubricant reservoir) 35 when the ring 130 passes through the oil sump 35 such that a chemical bond, specifically an electron bond between electrons, of the oil ring 130, specifically the coating 140, and the oil 35a is formed thus improving lubrication, dampening, and/or temperature between the oil ring 130 and the electrodynamic machine 10, in particular shaft 15 and/or bearings 25 of the machine 10.

According to an exemplary embodiment, the oil ring 130 is coated with a material that interacts with the machine oil 35a on an electrostatic level, thus creating an electrostatic attraction between the oil 35a and the coating 140 allowing the oil ring 130 to collect and deliver more oil 35a from the oil sump 35 to the bearings 25.

The triboelectric effect (also known as triboelectric charging) is a type of contact electrification in which certain materials become electrically charged after they come into frictive contact with a different material. The triboelectric series lists materials in order of the polarity of charge separation when they are touched with another object/material.

Relative positions of the machine oil 35a and the material of the coating 140 in the triboelectric series are such that when the materials, i.e., the machine oil 35a and the coating 140, are rubbed together, they exchange electrons and a net charge is developed, causing an attractive force between the materials. As the oil ring 130 passes through the oil sump 35, the coating 140 rubs against the oil 35a and creates an attractive charge that allows more oil 35a to be lifted by the ring 130.

At least a portion or the complete outer surface 134, the inner surface 132, and side surfaces 136, 138 can comprise the coating 140. According to FIG. 7, a portion of the outer surface 134 and a portion of the inner surface 134 comprise the coating 140. In an alternative embodiment, the complete ring 130 can comprise the coating 140, i.e. all the surfaces 132, 134, 136 and 138 are completely covered by the coating 140. In a further alternative embodiment, the ring 130 consists of the material of the coating, i.e., can be for example manufactured from the material of the coating 140.

The coating 140 of the oil ring 130 comprises for example a material with an appreciable difference in relative electro-negativity from machine oil (which is typically used as lubrication for rotating machines) in the triboelectric series, for example and without limitation Teflon®, PVC (Polyvinylchloride), and the like. According to the triboelectric series, machine oil comprises a positive charge affinity value of +29 nC/J. In contrast, PVC comprises a negative charge affinity value of −100 nC/J, and Teflon® comprises a negative charge affinity value of −190 nC/J. As the machine oil and the suggested coating materials comprise opposed charge affinity values, the materials will attract one another when the oil ring 130 is in motion and passes through the oil 35a in the oil sump 35. One of ordinary skill in the art appreciates that many other materials comprising a negative charge affinity value distant to the positive charge affinity value of machine oil may be used.

FIG. 7 further illustrates gravitational force 102 to show the general arrangement of the oil ring 130, particularly when arranged on a machine shaft. Rotation 104 is also shown; even though a clockwise rotation is shown, one skilled in the art can appreciate that a counter-clockwise rotation is possible. As illustrated, viscous force 106 is shown, and is generally in opposite to the gravitational force 102.

FIG. 8 illustrates a schematic 2-dimensional view of a further embodiment of an oil ring. As noted before, an oil ring can comprise many different designs, shapes and forms. FIG. 8 shows that the oil ring 150 comprises an annular ring body 152 in form of a torus with a closed surface 154 that is compact and without boundary. The oil ring 150 comprises electrostatic coating 156 distributed over the surface 154 of the ring 150. As noted before, it is also possible that the complete surface 154 of the ring 150 comprises the coating 156, or that the oil ring 150 is completely constructed from the material of the coating 156.

The provided electrostatic oil ring 130, 150 and a corresponding oil ring assembly with a plurality of oil rings 130, 150 are a simple and inexpensive way to improve the bearing temperature performance in any electrodynamic machine utilizing oil rings. Further, by increasing the oil supply between the oil ring 130, 150 and a machine shaft, the lubrication can also decrease the overall temperature of the machine, as friction can be reduced. Further, because of damping provided by the additional oil, vibration in the machine can be reduced. Consequently, the overall performance of an electrodynamic machine is improved and, further, less repairs or shut downs are necessary.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

1.-20. (canceled)

21. An electrostatic oil ring comprising an annular ring body with a surface, wherein at least a portion of the surface carries an electrostatic coating which electrostatically attracts lubricant in a lubricant reservoir when the oil ring passes through the lubricant reservoir.

22. The electrostatic oil ring of claim 21, wherein the annular ring body comprises a form of a hollow cylinder with an inner surface, an outer surface, and side surfaces, wherein at least a portion of the inner surface, the outer surface or the side surfaces carries the electrostatic coating.

23. The electrostatic oil ring of claim 21, wherein the annular ring body comprises a form of a toms with a closed surface, wherein a least a portion of the closed surface carries the electrostatic coating.

24. The electrostatic oil ring of claim 21, wherein the electrostatic coating comprises material with a charge affinity value that is different from a charge affinity value of the lubricant.

25. The electrostatic oil ring of claim 24, wherein the electrostatic coating comprises material with a negative charge affinity value and the lubricant comprises a positive charge affinity value.

26. The electrostatic oil ring of claim 21, wherein the electrostatic coating comprises Teflon® or Polyvinylchloride or a combination thereof

27. The electrostatic oil ring of claim 21, wherein the annular ring body is constructed from material of the electrostatic coating.

28. An electrostatic oil ring assembly comprising a plurality of electrostatic oil rings, each oil ring comprising an annular ring body with a surface, wherein at least a portion of the surface carries an electrostatic coating which electrostatically attracts lubricant in a lubricant reservoir when the oil ring passes through the lubricant reservoir.

29. The electrostatic oil ring assembly of claim 28, wherein the electrostatic coating comprises material adapted to create a chemical bond with the lubricant.

30. The electrostatic oil ring assembly of claim 28, wherein each oil ring comprises metal.

31. The electrostatic oil ring assembly of claim 28, wherein the electrostatic coating comprises Teflon® or Polyvinylchloride (PVC) or a combination thereof

32. An electrodynamic machine comprising:
an internal lubricant reservoir; and
at least one hydrodynamic bearing without a pressurized oil feed system, the hydrodynamic bearing comprising at least one oil ring in fluid communication with lubricant in the internal lubricant reservoir, the at least one oil ring comprising an annular ring body with a surface, wherein at least a portion of the surface carries an electrostatic coating.

33. The electrodynamic machine of claim 32, wherein the electrostatic coating electrostatically attracts the lubricant in the internal lubricant reservoir when the oil ring passes through the lubricant reservoir.

34. The electrodynamic machine of claim 32, further comprising:
a rotatable shaft defining at least one journal in rotatable engagement with the at least one hydrodynamic bearing;
an electrically powered lubricant reservoir pump oriented within the internal lubricant reservoir;
a lubricant intake coupled to the lubricant reservoir pump that is in fluid communication with the lubricant in the internal lubricant reservoir;
a lubricant discharge line external and independent from the at least one hydrodynamic bearing, the lubricant discharge line oriented proximal the at least one hydrodynamic bearing so that lubricant discharged from the lubricant discharge line replenishes lubricant in the at least one hydrodynamic bearing.

35. The electrodynamic machine of any of the preceding claim 32, further comprising:
a control unit coupled to the machine via communications pathway, the control unit further being coupled to the lubricant reservoir pump for varying parameters of the lubricant reservoir pump based on operating parameters or in reaction to sensed variations in operating parameters of the electrodynamic machine.

36. The electrodynamic machine of any of the preceding claim 32, wherein the electrodynamic machine is an induction motor.

37. The electrodynamic machine of any of the preceding claim 32, comprising a plurality of hydrodynamic bearings, each hydrodynamic bearing carrying a plurality of oil rings for depositing lubricant into the plurality of hydrodynamic bearings.

38. The electrodynamic machine of any of the preceding claim 32, wherein the electrostatic coating comprises material adapted to create a chemical bond with the lubricant.

39. The electrodynamic machine of any of the preceding claim 32, wherein each oil ring comprises metal.

40. The electrodynamic machine of any of the preceding claim 32, wherein the electrostatic coating comprises Teflon® or Polyvinylchloride or a combination thereof.
